(19) United States
(12) Patent Application Publication
(10) Pub. No.: US 2005/0021862 A1
(43) Pub. Date: Jan. 27, 2005

(54) Automatic selection of content-delivery provider using link mapping database

(75) Inventors: Ken Schroeder, Los Altos, CA (US); Christopher C. Marino, San Mateo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: DICKENS COAL LLC, Los Altos, CA (US)

(21) Appl. No.: 10/833,157

(22) Filed: Apr. 27, 2004

Related U.S. Application Data
(63) Continuation of application No. 09/540,863, filed on Mar. 31, 2000, now abandoned.

(51) Int. Cl. G06F 15/16

(52) U.S. Cl. 709/246; 709/219; 715/513

(57) ABSTRACT

A link-modifying web server automatically modifies links in each web page as it is served to a client browser. The web page is parsed for links, and the links are looked up in a link mapping database. A replacement field is read from the database. A link modifier alters the link using the replacement field to point to a different server at one of several content delivery providers. One of several replacement links can be selected from the link mapping database depending on network conditions and user account data. A replacement link to one content delivery provider can be chosen rather than another replacement link to a different content delivery provider when one provider's network is responding more quickly or has a lower cost. A provider monitor continuously checks provider performance at each of the content delivery providers. When one provider's network is slow or fails, the provider monitor instructs a delivery rule processor to choose link replacements at other content delivery providers. Thus the links in the web page served to the client are modified to point away from slow or failed providers.

### FIELD OF THE INVENTION

This invention relates to Internet content delivery, and more particularly to link modification to select a content delivery provider.

### BACKGROUND OF THE INVENTION

Use of the Internet has rapidly progressed from browsing of simple text-based web pages to more complex e-commerce and on-line instructional applications. Many web pages mix dynamic (generated on the fly) text with static (unchanging) graphics, audio, and video. Catalog pages can include video frames showing items for sale from different angles or showing operation of the item. Business-to-business (B2B) e-commerce web sites can include video-based instruction manuals or 3-D images for parts specifications. Dynamic content must be served from web servers in the web site, but the static graphics, audio, and video can be served from a cache anywhere in the internet.

High-bandwidth static content can be served by special remote servers owned by a content delivery provider, while text and simple graphics are served by the company's own servers. This offloads the data-intensive content to another company's servers, while still allowing the company to quickly and easily change the text of their web pages since the web-page text is served from the company's own servers. Content delivery providers can copy content to several different remote servers at different geographic locations.

Faster access can then occur since users are connected to the closest or least-busy remote server. Video and audio hosting is provided by companies such as Akamai of Cambridge, Mass., Digital Island of San Francisco, Calif., and iBeam of Sunnyvale, Calif.

FIG. 1 shows a composite web page with text, graphics, video and audio. Web page 20 contains text 22 and graphics image 26. Frame 24 displays a video and/or generates audio. Web page 20 is provided by company.com as a file in formats such as hyper-text mark-up language (HTML) or extensible markup language (XML). Text 22 is embedded directly in the HTML file, while the HTML file contains HTML tags that link the page to other files. For example, a tag link in the HTML file causes a web browser to retrieve a graphics file to display graphics image 26. The graphics image is not stored within the HTML file, but instead a tag in the file causes the browser to retrieve the graphics file and display it with the text in the web page from the HTML file. Likewise, video frame 24 is called up by a tag link within the HTML file, but the video and audio data is not contained in the HTML file. Using links rather than storing multimedia reduces the size of the HTML file.

The linked multimedia can reside on a different server. For example, a local web server at company.com can serve the text with the HTML file when a user requests the web page. The links within the HTML file cause the user's browser to access a remote server at a content distribution provider. The graphics, video, or audio files are read from these remote servers rather than from company.com's web servers. This offloads the larger graphics and video files to the remote servers, reducing the load on company.com's local servers.

FIG. 2 illustrates a web page being retrieved from a company's own server with links to multimedia files served by remote servers of content delivery providers. Web pages including text, graphics, videos, and audio clips are generated by content publisher 10, which can be internal groups such as marketing, sales, and investor relations groups at a company. The web pages are copied to the company's local web servers, which store and serve company.com web site 16. These web pages include text and simple graphics, and links to other web pages and to multimedia files. The multimedia files are large, and would slow the connection to the Internet from web site 16 if they were served by the company's local web servers.

Instead, these large multimedia files are transmitted to remote servers at content delivery providers 12, 14. These large files can be transmitted via a satellite connection, or over the Internet backbone during low-traffic periods such as in the middle of the night. Content delivery providers 12, 14 are located in different cities A, B, and are operated by hosting companies that typically host web pages or video files from many different companies.

When a user operating browser 18 requests the company.com web page, the company.com uniform-resource-locator (URL) is looked up by a domain name service (DNS) to find the Internet Protocol (IP) address for that URL's high-level domain. Browser 18 then connects with this IP address, to web site 16. The company's local servers then send the HTML file for the company.com web page over the Internet to browser 18. This HTML file contains text that browser 18 displays to the user, and links to graphics and video files. Small graphics files may be retrieved by browser 18 reading these files from web site 16. However, the links for large video files direct browser 18 to contact content delivery provider 14 in city B. These video files are downloaded over the Internet from content delivery provider 14 directly to browser 18 for display to the user. Browser 18 arranges the video and graphics to be displayed on the user's screen next to the text in locations defined by the HTML file.

Ideally, content delivery provider 14 is chosen rather than content delivery provider 12 when browser 18 or its Internet Service Provider (ISP) is geographically closer to city B than city A. A load-balancing scheme such as described in U.S. Pat. No. 5,774,660 can also be used.

However, a network failure can make the video and graphics files served by content delivery provider 14 unavailable. To the user, this appears to be a failure at company.com, perhaps causing the user to view company.com as unreliable. This can damage the business reputation of the company. Also, since many other web sites are hosted by content delivery provider 14, one of the other sites may be experiencing heavy traffic, such as when a special event occurs at one of the other hosted sites, such as a superbowl site during the last weekend in January or a heavily-advertised fashion show.

Link Editing—FIGS. 3A, 3B

FIGS. 3A, 3B illustrate link editing to direct content requests to a content delivery provider. Links within a HTML file for a web page direct the browser to a location to retrieve graphics, video, and audio files, as well as other web pages.

In FIG. 3A, the content publisher includes a link tag in the HTML file for a web page. The “a” and “/a” delimit the link. The URL http://www.company.com retrieved this HTML file to display the company.com web page, as indicated by the HREF tag. The HTML file also contains an image source linking tag IMG_SRC that causes the browser to retrieved the graphics file air.gif from the company.com web site. Often the URL includes additional subdirectories such as for graphics files, but that is not shown in this simple example. The browser retrieves the air.gif file from the company.com web site and displays the graphics file on the screen at a position defined by the HTML file.

In FIG. 3B, the link to the air.gif graphics file in the image source tag has been edited to point to a file at a content delivery provider. The URL http://www.company.com still retrieves this HTML file to display the company.com web page, as indicated by the HREF tag. However, the image source tag IMG_SRC has been changed. Rather than reference a file on the company.com local web server, the edited image source tag refers to the content delivery provider's web site.

The edited image source tag now causes the browser to retrieve the graphics file air.gif from the content delivery provider web site www.deliv_net_A.com in the company.com directory. Often the URL used by a content delivery provider includes additional subdirectories such as: www.deliv_net_A.com/company_data/www.company.com/graphics_file/air.gif but this full URL is simplified in the examples.

This process of changing links is typically done by writing small programs such as scripts that parse the HTML web-page files and modify selected links. Such manual link editing is undesirable since valuable programmer time is required to write and test the scripts, and to run the scripts on all web pages when the links need to be changed. For example, when a new content delivery provider is used, all video and graphics links on each of many web pages need to be edited, and the modified HTML files re-loaded to the company's web site.

Companies may be reluctant to switch content delivery providers, due to the high cost and hassle of editing links. A large web site can have many links that need to be edited, and the possibility exists of missing hidden links on obscure pages at seldom-used parts of the web site.

The links are typically modified late in the content production process, often after the content is generated and verified. An extra step to run the link-editing scripts is added to the production process. This extra step can be a source of error.

When a failure occurs at the content delivery provider, many web pages may have links to the failed servers at the content delivery provider. The scripts need to be re-written to edit the links to point to a different content delivery provider, and the new scripts re-run on all these web pages to bypass the failure. It can easily take several hours to perform these edits, by which time the failure may have ended. During that time, the links to the content delivery provider are “dead links” since the linked files are not available.

Link editing on a client kiosk to manage the user's experience is taught by Logan et al. in U.S. Pat. No. 5,761,683. Client-side link modification is also taught by Rangan et al. in U.S. Pat. No. 6,006,265 for a hyper-video application. Cohen et al. teaches changing links based on the hardware resources of the display terminal in U.S. Pat. No. 5,367,621. Groups of pages are linked together by Liu et al. in U.S. Pat. No. 5,794,257.

While such link editing is useful, it is desired to modify links on-the-fly as web pages are served to the client. It is desired to modify these links to re-direct web requests to one of several content delivery providers, depending on factors such as user location, network availability, cost, and failures.

What is desired is an automatic link modifier. A server-side run-time link modifier is desired that automatically modifies links on each web page as each web page is being served to the user. An easily-verified method for modifying links in content is desirable. It is desired to automatically modify links to allow content producers to easily and quickly change delivery providers in response to network or server outages, to lower costs, or to provide better service. It is desired to allow links to be modified on a user-by-user basis so that content can be delivered from a content delivery provider that is geographically closest to the user, or based on the user profile or account level.

### SUMMARY OF THE INVENTION

A link-modifying web server has a network connection that receives a request from a client for a web page file. A file server is for storing or generating web page files. A link modifier receives a web page file from the file server in response to a request from the client. It extracts an extracted link from the web page file. The extracted link enables fetching of a linked web file.

A link mapping database is coupled to receive the extracted link from the link modifier. It outputs a plurality of replacement fields for the extracted link. Each of the replacement fields generates a link to a different content delivery provider for serving the linked web file.

A provider selector receives the replacement fields from the link mapping database. It selects a selected replacement field for a selected content delivery provider. The link modifier receives the selected replacement field from the provider selector. The link modifier uses the selected replacement field to generate a modified link in the web page file to generate a modified-link web page file.

The network connection sends the modified-link web page file to the client. The client fetches the linked web file from the selected content delivery provider rather than from the link-modifying web server when the modified link is activated. Thus links are modified to fetch the linked web file from the selected content delivery provider.

In further aspects of the invention the link modifier has a link parser that receives the web page file from the content storage. It locates links within the web page file and outputs the extracted link. The link parser sends a plurality of extracted links to the link mapping database.

In still further aspects of the invention the extracted link is a portion of a fully-specified link. The replacement fields contain a portion of a fully-specified link. Thus portions of links are looked up and stored in the link mapping database.

In other aspects the extracted link is a keyword extracted from an original link in the web page file. The link mapping database is indexed by keywords used to locate a matching entry in the link mapping database. The matching entry has the plurality of replacement fields. Thus the keywords extracted from the original links are indexes for selecting the matching entry in the link mapping database.

In other aspects the keyword indicates a type of content in the linked web file. The type of content is a type of multimedia content including graphics, video, or audio.

In other aspects the extracted link is a full link that includes a high-level domain and a directory tree and a file name for the linked web file stored at the link-modifying web server. Thus full links are extracted and looked up in the link mapping database.

In still further aspects of the invention the content delivery provider is selected based on measured performance. A performance monitor sends requests to each of the content delivery providers. The performance monitor measures response times from each of the content delivery providers and sends a performance signal to the provider selector to indicate which content delivery provider has better response times. The provider selector uses the performance signal from the performance monitor to select the selected content delivery provider. Thus content delivery providers are selected based on monitored provider performance.

### BRIEF DESCRIPTION OF THE DRAWINGS

FIG. 1 shows a composite web page with text, graphics, video and audio.

FIG. 2 illustrates a web page being retrieved from a company's own server with links to multimedia files served by remote servers of content delivery providers.

FIGS. 3A, 3B illustrate link editing to direct content requests to a content delivery provider.

FIG. 4 is a diagram of a link-modifying web server serving web pages to a browser with links modified as web pages are served.

FIGS. 5A-C show a link being modified by matching keywords in the link.

FIG. 6 illustrates a link mapping database that is indexed by keywords extracted from links in web-page files.

FIGS. 7A-C show a link being modified by matching a full link.

FIG. 8 illustrates a link mapping database that is indexed by links extracted from web-page files.

FIGS. 9A-C show a link being modified by rule-based link matching.

FIG. 10 illustrates a link mapping database that is indexed by matching a regular expression to links extracted from web-page files.

FIG. 11 shows a link modifier that consults a user accounts database to determine which of several content delivery providers to direct the user's requests to by link re-mapping.

FIG. 12 shows a link modifier that monitors network performance and current delivery costs to determine which of several content delivery providers to direct the user's requests to by link re-mapping.

FIG. 13 highlights a link-modifying web server that monitors network conditions and directs users through modified links to a best-available content delivery provider.

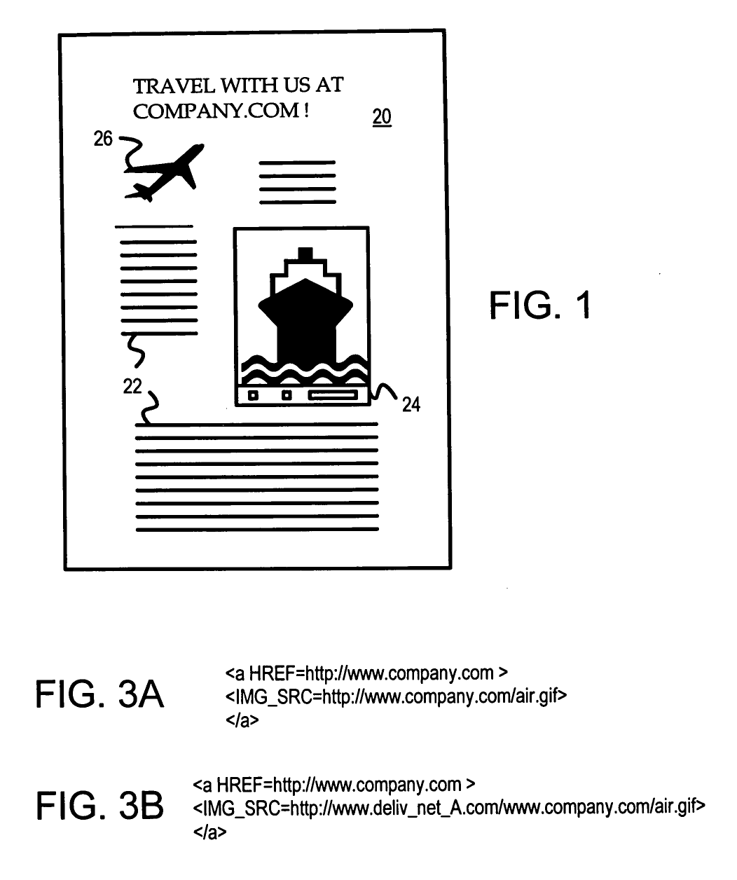

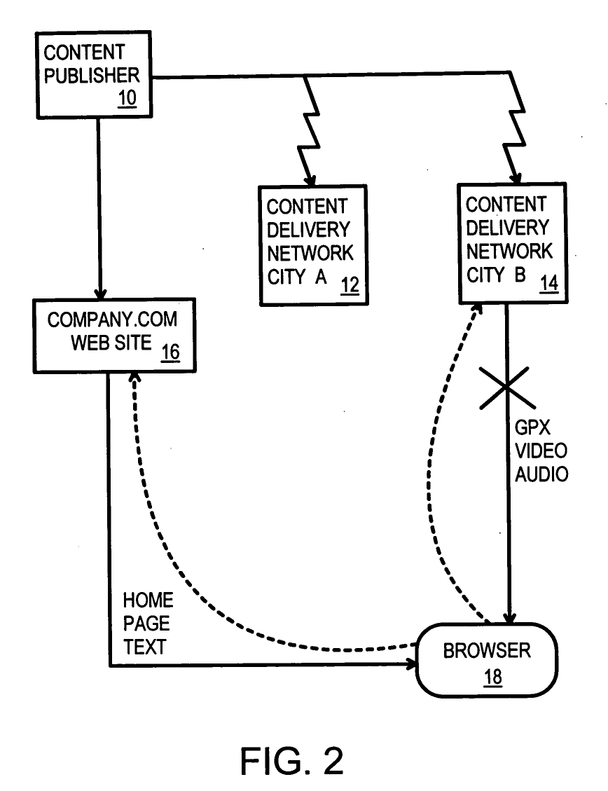

### DETAILED DESCRIPTION

The present invention relates to an improvement in network reliability using link modification. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The inventors have realized that reliability can be improved if web requests can be directed to any one of several content delivery providers. When one content delivery providers has a failure or a slow response due to heavy instantaneous traffic, web requests can be directed to other content delivery providers.

The inventors have further realized that directing web requests to the content delivery providers can be controlled by the links within a web page. The inventors change these links to direct web requests to the most-reliable or lowest-cost provider at any given time.

The inventors further realize that these links can be modified on-the-fly as a web page is being served to the client's browser. The links are modified on the web server just before the web page is sent to the client. A link mapping database is used by a link modifier to change the links to point to a particular content delivery provider. Links for graphics, audio, or video can be modified to point to specialized service providers, such as video content delivery providers. The web page's basic HTML file and text can be delivered by a company's own web servers, while the links on the web page are modified to have the browser fetch the video links from the chosen content delivery provider.

Since the choice of the content delivery provider is made just before the web page is sent from the company's server to the browser, the most available content delivery provider at that instant in time can be chosen. When one content delivery provider fails, traffic can immediately and automatically be re-directed to another content delivery provider.

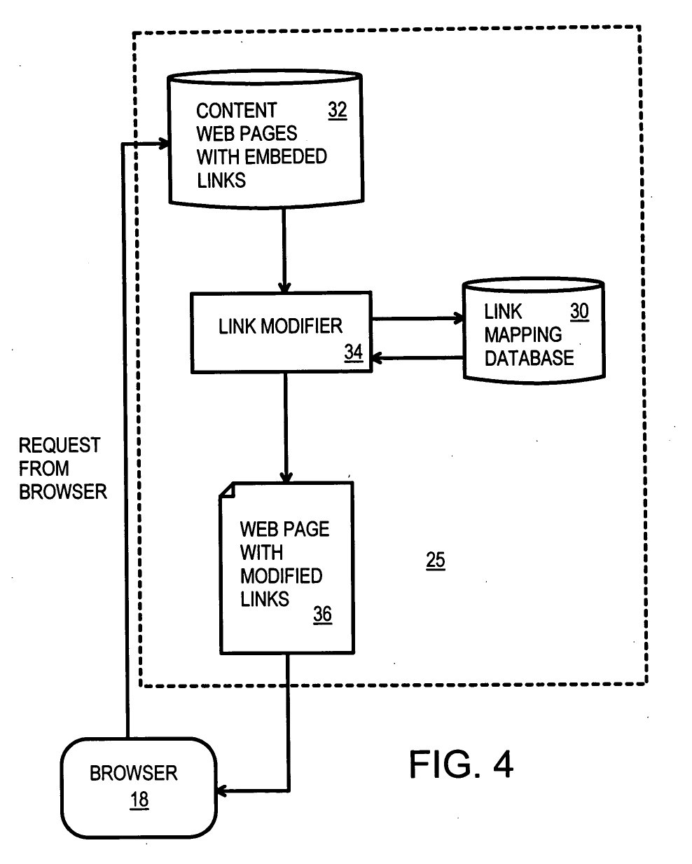

Link-Modifying Web Server—FIG. 4

FIG. 4 is a diagram of a link-modifying web server serving web pages to a browser with links modified as web pages are served. Browser 18 sends a request for a web page over the Internet to web server 25. Web server 25 can be one of several machines at a web server farm, and the components can be distributed across several of the machines. Web server 25 receives the request from browser 18 and determines which web page document is being requested by the URL from browser 18. The desired web page is retrieved from content storage 32 as an HTML or XML document or file. This file contains hyper-links or links that are URL's for other web pages or files, such as graphic image files, scripts that generate a video frame on the displayed web page, and audio-generating links or pop-up windows that appear over the displayed web page.

The requested web-page file is read from content storage 32 and then processed by link modifier 34. Link modifier 34 scans or parses the HTML or XML tags within the web-page file read from content storage 32 to locate tags with links. Each of these links located by link modifier 34 is then looked up in link mapping database 30. When a matching link entry is found in link mapping database 30, then a modified link, or a modifying rule is read from link mapping database 30. Link modifier 34 replaces all or a portion of the original link in the file read from content storage 32 with the modified link from link mapping database 30. Alternately, link modifier 34 can use the link-modifying rule read from link mapping database 30 to modify the link.

Once all links in the file read from content storage 32 are processed by link modifier 34, the modified web-page document 36 is transmitted through the Internet and to browser 18. Typically web-page document 36 is divided into smaller TCP/IP packets that are routed over the Internet to browser 18 and re-ordered for display.

Browser 18 displays the web page to the user using the text and commands in web-page document 36. When a link tag is found in web-page document 36, browser 18 uses the URL in the link in another request that is sent over the Internet. This URL may point to a different web server, such as at a content delivery provider. Browser 18 sends the new request to the content delivery provider, retrieving graphics, video, audio, or other information that is displayed with the text from web-page document 36.

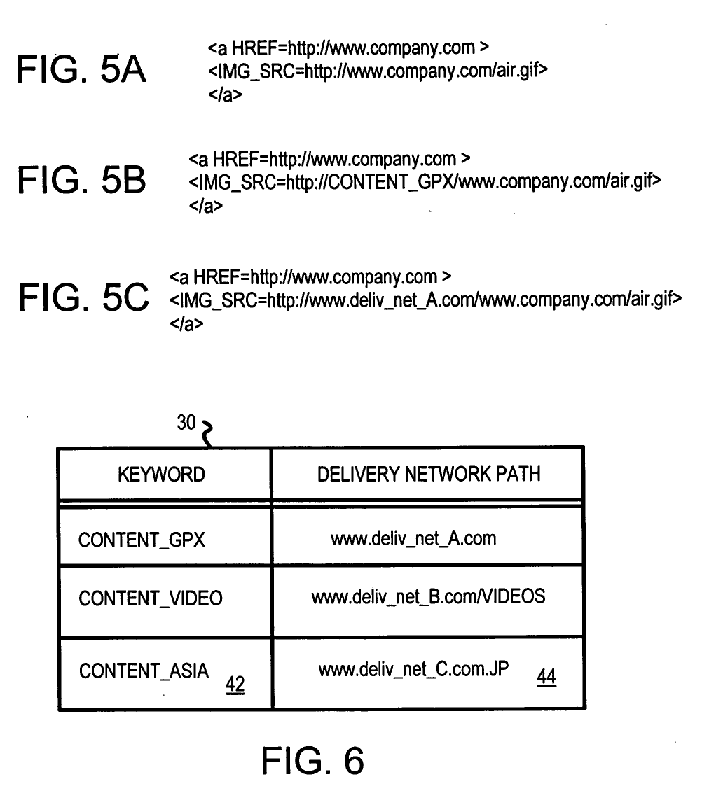

Keyword-Based Link Modification —FIGS. 5, 6

FIGS. 5A-C show a link being modified by matching keywords in the link. In FIG. 5A, an original link in the home page for company.com is shown as it appears in the HTML file read from the content storage at the company's web server. The image source tag in the HTML file is a link to the file air.gif, which is a graphics image file in the GIF graphics format. The link directs a browser to read the file from the root directory at the company.com web server. The URL http://www.company.com/air.gif can be sent by a browser as a web request to fetch the air.gif file.

However, the air.gif file may be a large graphics file. The company's own web servers may be slowed considerably if many users request this large file at the same time. To avoid this problem, the company contracts with one or more content delivery providers. The air.gif file is sent to the content delivery providers and they serve this file to users, while company.com's own web servers serve the basic HTML files with most of the text displayed on the web page. Since the HTML file is much smaller in size than the graphics and multimedia files, the bulk of the data traffic is off-loaded to the content delivery providers.

In FIG. 5B, the link has been manually edited to include a keyword in the link matching in order to have a content delivery provider serve the air.gif file. The content publisher or web administrator edits the HTML file of FIG. 5A to add the keyword “CONTENT_GPX” to the URL in the link for the air.gif file. Before the file is served, the keyword is replaced with the path to the content provider.

FIG. 5C shows an HTML file after automatic link modification that uses keyword matching. When an HTML or XML file is processed by the link modifier, the link modifier searches the file for instances of the keyword “CONTENT_GPX”. When this keyword is found, the link mapping database is consulted to find a replacement for the keyword. The replacement is substituted for the keyword in the URL link. In this example, the keyword CONTENT_GPX is replaced by www.deliv_net_A.com in the link. This causes the browser to fetch the air.gif file from delivery provider A rather than from company.com's web servers. Delivery provider A is a content delivery provider that stores all files for company.com in the directory www.company.com at its web servers.

In actual practice, additional levels of subdirectories are often used by content delivery providers, and these additional levels can be included in the replacement stored in link mapping database. For example, the content delivery provider may store the gif file in the directory bestclients/companyC/graphics/homepage/, so the keyword CONTENT_GPX is replaced by the string “www.deliv_net_A.com/bestclients/companyC/graphics/homepage” to form a longer URL that points to the correct subdirectory.

Adding keywords to links does require an extra step when the content files are being developed. However, the added keywords allow for quick link modification without human intervention later, such as when a network outage hits one of the content delivery providers. One or more keywords can be added for all graphics files, while another keyword can be used for video links. This allows graphics files to be directed to one content delivery provider, while video files are directed to another content delivery provider. Some keywords could prevent external linking, such as for secure video data that is not sent off-site to the content delivery providers. Alternately, some keywords could be used for secure files that are stored by one content delivery providers with better security than the other content delivery providers.

FIG. 6 illustrates a link mapping database that is indexed by keywords extracted from links in web-page files. Link mapping database 30 stores keywords in index fields 42. Each entry in link mapping database 30 is selected by matching a keyword extracted by the link modifier to one of the index fields 42. For example, the keyword CONTENT_GPX is matched by the first entry.

Replacement field 44 contains parts of URL's that are substituted for the keyword by the link modifier. When the keyword CONTENT_GPX is sent to link mapping database 30, the first entry is selected, and its replacement field 44 is output. The link modifier replaces the keyword CONTENT_GPX with “www.delvi_net_A.com” from replacement field 44.

Other keywords cause different replacements to be applied. The keyword CONTENT_VDEO matches the second entry, causing the link to be modified to point to the videos directory at content delivery provider B. The keyword CONTENT_ASIA modifies the link using the third entry to direct requests to content delivery provider C that is located in Japan (.jp). Special Asia-related content could thus be served from web servers based in Asia, which could reduce bandwidth charges and speed delivery of web pages if the users reading the content are primarily based in the Far East.

Thus the keywords can be added to links for certain types of content files, such as graphics or videos, or geographic-specific content. These content-type keywords then direct traffic to the content delivery provider best suited for that type of content. Providers that specialize in video can serve the video files, while providers in one geographic region can serve content about that region.

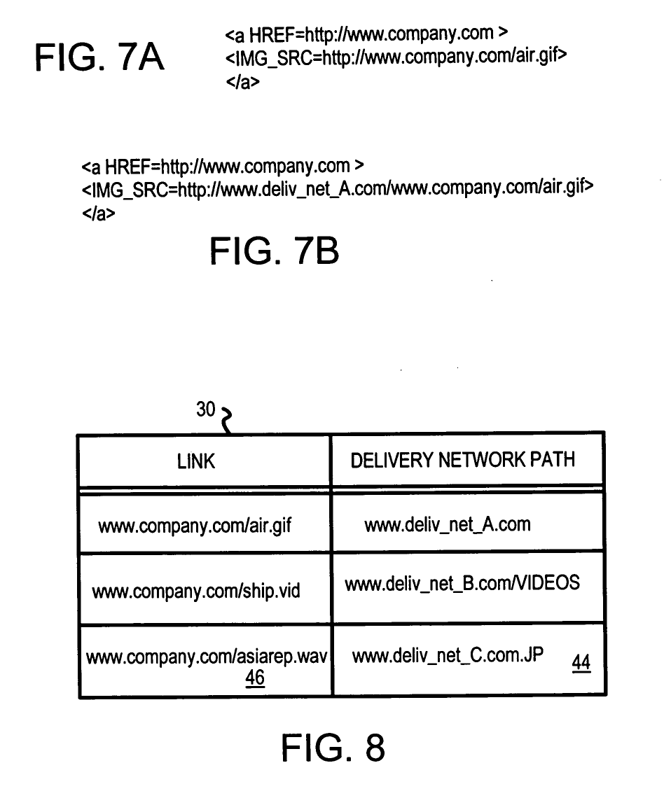

Link-Matching Link Modification —FIGS. 7, 8

FIGS. 7A-C show a link being modified by matching a full link. In FIG. 7A, an original link in the home page for company.com is shown, which is the link appearing in the HTML file read from content storage at the company's web server. The image source tag in the HTML file is a link to the file air.gif, a graphics image file. The link directs a browser to read the file from the root directory at the company.com web server.

In FIG. 7B, the link in the HTML file has been automatically modified. When an HTML or XML file is processed by the link modifier, the link modifier searches the file for instances of each indexed link stored in the link mapping database. When one of the indexed links is found in the HTML file, the replacement link is read from the matching entry in the mapping database. The replacement link is substituted for all or a part of the matched (indexed) link.

In this example, the link “www.company.com/air.gif” is replaced by “www.deliv_net_A.com/www.company.com/air.gif”. This causes the browser to fetch the air.gif file from delivery provider A rather than from company.com's web servers. Delivery provider A is a content delivery provider that stores all files for company.com in the directory www.company.com at its web servers.

In actual practice, additional levels of subdirectories are often used by content delivery providers, and these additional levels can be included in the replacement stored in link mapping database. The link modifier can match an entire link while replacing just a portion of the link. In a preferred embodiment, the indexed link is not replaced, but is pre-pended with the replacement link from the link mapping database.

Adding keywords to links is not required with the link-matching method. No extra step is needed to manually add keywords when the content files are developed. Different links can be matched, allowing requests to be directed to different content delivery providers with a single-link granularity rather than mapping all links in one category to the same content delivery provider.

Links can be added to the index field of the link mapping database for all graphics files and video links. Some graphics files to be directed to one content delivery provider, while other graphics or video files can be directed to another content delivery provider.

FIG. 8 illustrates a link mapping database that is indexed by links extracted from web-page files. Link mapping database 30 stores full-URL links in index fields 46, except that the http:// start has been dropped. Each entry in link mapping database 30 is selected by matching a link extracted by the link modifier to one of the index fields 46. For example, the link “www.company.com/air.gif” is matched by the first entry.

Replacement field 44 contains parts of URL's that are substituted for the indexed link by the link modifier. When the link “www.company.com/air.gif” is sent to link mapping database 30, the first entry is selected, and its replacement field 44 is output. The link modifier appends the indexed link “www.company.com/air.gif” to “www.delvi_net_A.com” from replacement field 44. The indexed link is not replaced but is appended to the end of the string from replacement filed 44 to produce the final link “www.delvi_net_A.com/www.company.com/air.gif”.

Other links cause different replacements to be applied. The link “www.company.com/ship.vid” matches the second entry, causing the link to be modified to point to the videos directory at content delivery provider B. The indexed link “www.company.com/asiarep.wav” matches the third entry and is pre-pended with “www.delvi_net_C.com.jp” to direct requests to content delivery provider C that is located in Japan (.jp).

Thus the full links can be matched with index field 46 and combined with the replacement field 44 to generate the modified link. Individual links can be individually mapped. Certain content files, such as a graphics or video file, or geographic-specific content files can be mapped. Full-link mapping can direct traffic to the content delivery provider best suited for that particular content file.

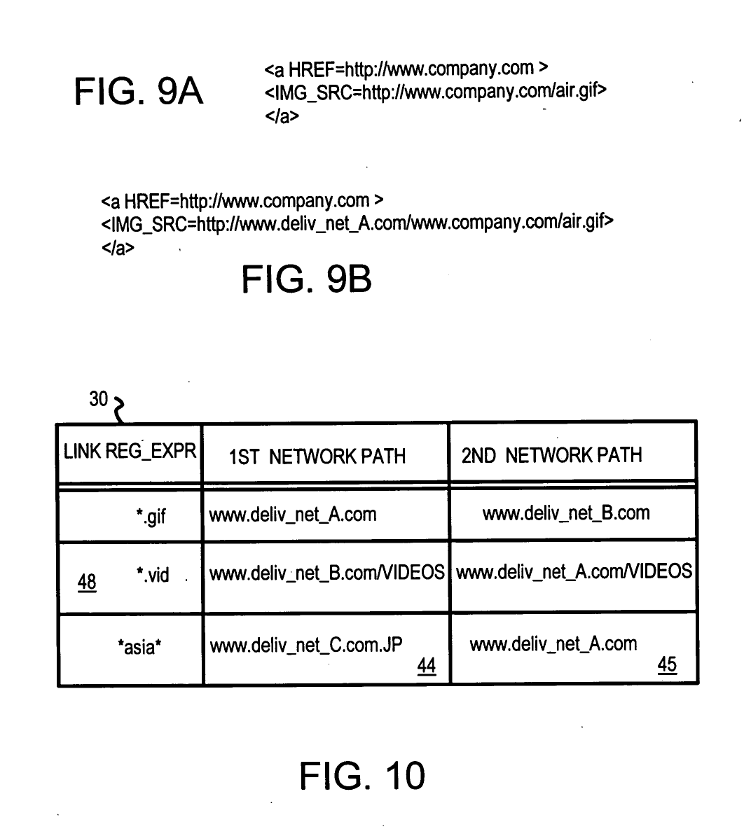

Rule-Based Link Modification—FIGS. 9, 10

FIGS. 9A-C show a link being modified by rule-based link matching. In FIG. 9A, the original link in the home page for company.com is shown again. The image source tag in the HTML file is a link to the file air.gif, a graphics image file.

In FIG. 9B, the link in the HTML file has been automatically modified using a regular expression. When an HTML or XML file is processed by the link modifier, the link modifier searches the file for instances of each regular expression stored in the link mapping database. When a link in the HTML file matches one of the regular expressions, the replacement link is read from the matching entry in the mapping database. The replacement link is substituted for all or a part of the matched link.

Regular expressions often use wildcard characters. For example, the asterisk can match any character or characters. Other operators can be used in the regular expression, such as ORing, exclusive-ORing, and nested operations. Different wildcards can be used, such as “.” that matches just one character, or “[0-9] ” that matches a number but not a letter.

In this example, the link “www.company.com/air.gif” matches the regular expression “*.gif”. This regular expression matches all graphics files in the GIF format. The link is replaced by “www.deliv_net_A.com/www.compamy.com/air.gif”. The browser fetches the air.gif file from delivery provider A rather than from company.com's web servers. Additional levels of subdirectories can be added, but are omitted for clarity. The link matching the regular expression is not replaced, but is pre-pended with the replacement link from the link mapping database.

Adding keywords to links is not required with the rule-based matching method. Fewer entries in the link mapping database are needed than for the full-link method of FIG. 8, since each regular expression can match many different link with the same pattern.

Processing by the link modifier may be increased, depending on the complexity of the regular expressions used. However, no extra step is needed to manually add keywords when the content files are developed. Different patterns of links can be matched, allowing requests to be directed to different content delivery providers with a pattern-grouped link granularity rather than mapping all links in one category to the same content delivery provider.

Links can be added to the index field of the link mapping database for all graphics, video, or audio files of a certain format. Some graphics files to be directed to one content delivery provider, while other graphics or video files can be directed to another content delivery provider. Each content delivery provider could use it's own different file format.

FIG. 10 illustrates a link mapping database that is indexed by matching a regular expression to links extracted from web-page files. Link mapping database 30 stores patterns or regular expressions in pattern fields 48. Each entry in link mapping database 30 is selected by matching a link extracted by the link modifier to one of the pattern fields 46. For example, the link “www.company.com/air.gif” is matched by the pattern *.gif stored in the first entry.

Replacement field 44 contains parts of URL's that are substituted for the indexed link by the link modifier. When the link “www.company.com/air.gif” is processed using the patterns in pattern fields 48, the first pattern *.gif is matched, and the first entry is selected, and its replacement field 44 is output. The link modifier appends the original link “www.company.com/air.gif” to “www.delvi_net_A.com” from replacement field 44. The original link is not replaced but is appended to the end of the string from replacement filed 44 to produce the final link “www.delvi_net_A.com/www.company.com/air.gif”.

Other patterns match different links and cause different replacements to be applied. The link “www.company.com/ship.vid” matches the pattern *.vid for the second entry, causing the link to be modified to point to the videos directory at content delivery provider B. The indexed link “www.company.com/asiarep.wav” matches the pattern *asia* from the third entry and is pre-pended with “www.delvi_net_C.comjp” to direct requests to content delivery provider C that is located in Japan (jp). The regular expression *asia* matches any link with the word “aisa”, such as asiarep.wav, eurasia.doc. and firstasia2.gpx, while the expression *.gif matches only links that end with the gif file extension: firstreport.gif, but not any.gif.doc or agifagaf.vid.

Pattern matching is a powerful method, because it requires fewer entries in link mapping database, reducing the size of the mapping database and the memory bandwidth required. Many programmers know how to use regular expressions since regular expressions are taught in Unix classes and used in Perl Scripts. Complex patterns can be matched with regular expressions.

The link modifier must first read one or more of the patterns from the link mapping database, and then use the pattern as a rule that is used by the parser when searching the HTML file. Rather than match exact keywords or links (strings), inexact matching is searched for.

A second replacement is included in second replacement field 45. This second replacement is an alternate content delivery provider to the provider indicated by the replacement in replacement field 44. For example, the alternate provider for the first entry is content delivery provider B, while alternates for the second and third entries are content delivery provider A.

While the replacement in second replacement field 45 could be a less desirable, higher-cost, or otherwise secondary provider, in a later embodiment either provider from fields 44, 45 may be selected based on current network conditions and costs.

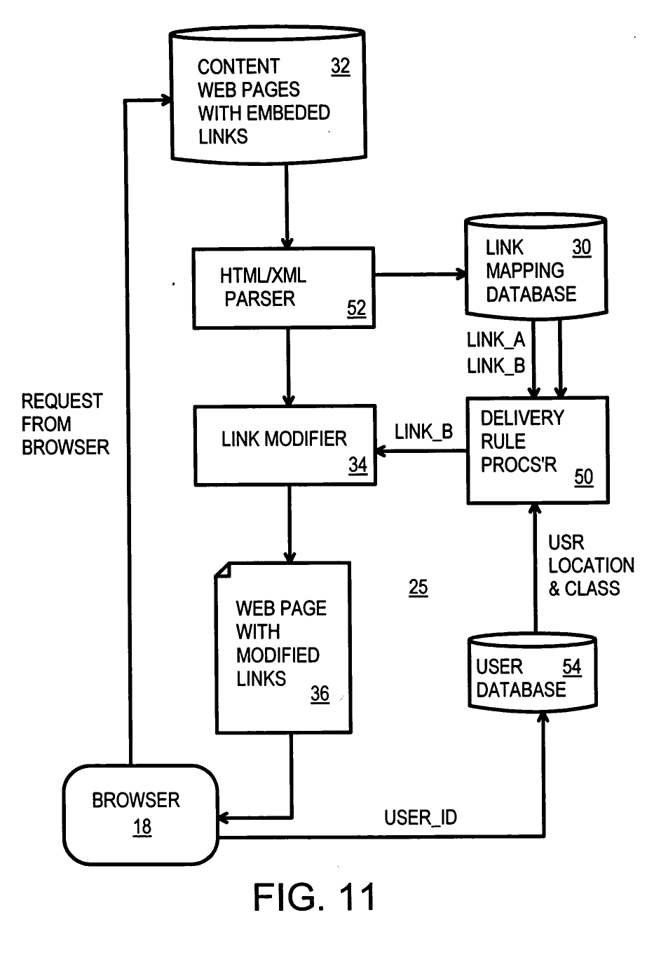

Account-Based Link Modifier—FIG. 11

FIG. 11 shows a link modifier that consults a user accounts database to determine which of several content delivery providers to direct the user's requests to by link re-mapping. Browser 18 requests a web page from server 25 at a company's web site. A web server application such as Apache uses the URL in the client's request to locate and read one or more HTML files from content storage 32; These HTML (or XML) files contain links to other web pages or to graphics and other multimedia files.

Each file read from content storage 32 is parsed by parser 52 to look for links. The links can be extracted and processed one-by-one, or all the links can be extracted into a temporary file for further batch-like processing. The links are used to index link mapping database 30, and a regular-expression module (not shown) may be used to look for pattern matches.

When an extracted link matches one of the index fields, the replacement field is read from the matching entry in link mapping database. Rather than have just one replacement for each entry, two or more replacements are stored with each entry in this embodiment. The two different replacements are for two alternative content delivery providers that can serve the indexed content. Both of these possible replacements are output from link mapping database 30, perhaps being combined with the original link to form new links LINK_A and LINK_B. LINK_A direct a request to provider A, while link B directs the request to provider B. Each content delivery provider has a copy of the same content or file, such as with mirrored sites.

When the user of browser 18 requests the web page from server 25, his user identifier (USER_ID) is also sent to server 25. User ID's can be stored in cookie files that are stored on the client and sent to the server with each request. Server 25 receives the user ID from browser 18 and looks up the user's account in accounts database 54. The user's record in accounts database 54 can include the user's geographic location, or the location within the Internet of his Internet Service Provider (ISP), and the level or status of his account (gold, silver, mud).

Delivery rule processor 50 receives the user's account.attributes from accounts database 54, and the modified links from link mapping database 30. Delivery rule processor 50 is programmed with pre-defined rules to select one of the possible content delivery providers for this link and this user. For example, user in Japan could be assigned to a content delivery provider in Japan. If LINK_B was to a Japanese content delivery provider, then delivery rule processor 50 selects LINK_B for uses in Japan, and LINK_A for other users.

The user's ISP may have a closer, faster connection to one content delivery provider than another. For example, users of aol.com may be connected to the Internet at Vienna, Va., regardless of their actual location. All AOL accounts could have their links mapped to a content delivery provider in the Northern Virginia area while most other .com users are mapped to a California content delivery provider.

It is also possible that LINK_B is for a content delivery provider with a faster but more costly provider. LINK_B could be chosen for Gold level accounts, but the slower, less costly LINK_A chosen for silver and lower level accounts. Perhaps new customers are assigned to the faster provider to make a better first impression.

The link corresponding to the content delivery provider chosen by delivery rule processor 50 is sent to link modifier 34. Link modifier 34 replaces the original link in the HTML file read from content storage 32 with the modified link chosen by delivery rule processor 50. Link modifier 34 may also simply pre-pend a portion of a link selected by delivery rule processor 50 from link mapping database 30 to the original link.

Once all mapped links are updated by link modifier 34, web-page document 36 is transmitted from server 25 to browser 18. Web-page document 36 contains the modified links that direct browser 18 to use the content delivery provider selected by delivery rule processor 50, based on the user's account record from accounts database 54.

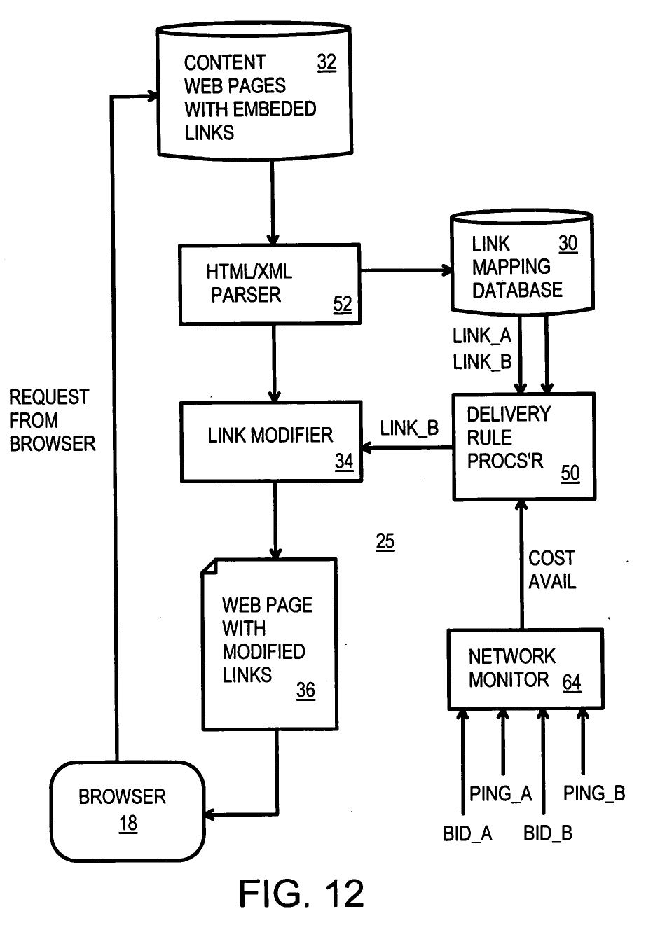

Provider Performance-Monitoring Link Modifier—FIG. 12

FIG. 12 shows a link modifier that monitors provider performance and current provider costs to determine which of several content delivery providers to direct the user's requests to by link re-mapping. Browser 18 requests a web page from server 25 at a company's web site. The URL in the client's request is used to locate and read one or more HTML files from content storage 32.

Each file read from content storage 32 is parsed by parser 52 to look for links. The links can be extracted and processed one-by-one, or by batch-like processing. The links are used to index link mapping database 30 to find a matching entry for each link. Normally only one matching entry exists for each link, and some links may not have any matching entries.

When an extracted link matches one of the index fields, the replacement field is read from the matching entry in link mapping database. Two or more replacements are stored with each entry, allowing for two or more content delivery providers that can serve the indexed content. All of these possible replacements are output from link mapping database 30, perhaps being combined with the original link to form new links LINK_A and LINK_B. LINK_A direct a request to provider A, while link B directs the request to provider B.

Performance monitor 64 is connected to the Internet and continuously or periodically monitors the performance of various content delivery providers used by the company. In a simple embodiment, network monitor 64 sends out pings to content delivery providers A and B, and measures the reply time. When one provider fails completely, the ping is not returned. Then performance monitor 64 signals provider selector 50 that the network is down. Then provider selector 50 must direct traffic to other content delivery providers.

For example, when performance monitor sends PING_A to content delivery provider A, but gets no reply, network monitor 64 signals provider selector 50 not to use provider A. Delivery rule processor 50 then selects LINK_B rather than LINK_A, regardless of any other selection criteria. This effectively routes traffic around failed providers. Since performance monitor 64 continuously and automatically checks provider status, provider failures are immediately detected and links are quickly modified to avoid the failure. The link modification to avoid the failure is transparent and can occur before network administrators are even aware of the failure.

More sophisticated network monitoring by network monitor 64 can be performed. For example, graphics or video files may be periodically requested by network monitor 64. The response times are measured for each content delivery provider, and the best-performing provider (either initial latency or overall bandwidth available) is determined and identified to delivery rule processor 50. This best-performing provider can then be selected for use in links modified by link modifier 34.

Network monitoring can be distributed, with monitors deployed at various locations on the internet to measure how well the content delivery network serves content to users in different regions or on different ISPs. The content delivery provider could then be selected based upon it's overall performance or based upon how well it performs for the particular user making the web request.

Content delivery provider costs can also be factored in. One content delivery provider A may have a fixed charge of $1 per Gbyte served, while provider B has a charge of $2 per GB. Ideally, delivery rule processor 50 selects links using provider A (LINK_B, not LINK_A) as much as possible to lower costs. However, should the performance of the lower-cost provider A fall below a threshold, the higher-cost provider can be selected by delivery rule processor 50. Rather than use a fixed threshold, as the performance of the lower-cost provider A decreases, the higher-cost provider can be selected for a higher percentage of the modified links. A formula such as a linear blending function can be used to adjust the mix of providers used as a function of content delivery provider delays and costs.

The provider costs may vary with time. If the costs vary on a fixed schedule, the rules used by delivery rule processor 50 can reflect these costs. If one provider raises its costs during business hours of 9-5, the other provider can be chosen during those hours. Provider costs can also vary instantaneously as conditions warrant. Cost bids from each provider (BID_A, BID_B) can be received by provider monitor 64 and transmitted to delivery rule processor 50 for input to the rule processing. When one provider experiences high traffic, such as during an event like the super bowl or after a TV advertisement is shown, it can raise its cost bid, or provider monitor 64 can detect slowed performance, allowing a different content delivery provider to be chosen until the traffic patterns return to normal.

Delivery rule processor 50 receives performance and cost attributes from provider monitor 64, and the modified links from link mapping database 30. Delivery rule processor 50 is programmed with pre-defined rules to select one of the possible content delivery providers for this link and the current provider conditions and costs.

The link corresponding to the content delivery provider chosen by provider selector 50 is sent to link modifier 34. Link modifier 34 replaces the original link in the HiML file read from content storage 32 with the modified link chosen by provider selector 50. Link modifier 34 may also pre-pend a portion of a link selected by provider selector 50 from link mapping database 30 to the original link.

Once all mapped links are updated by link modifier 34, web-page document 36 is transmitted from server 25 to browser 18. Web-page document 36 contains the modified links that direct browser 18 to use the content delivery provider selected by delivery rule processor 50, based on the current provider conditions and costs from provider monitor 64.

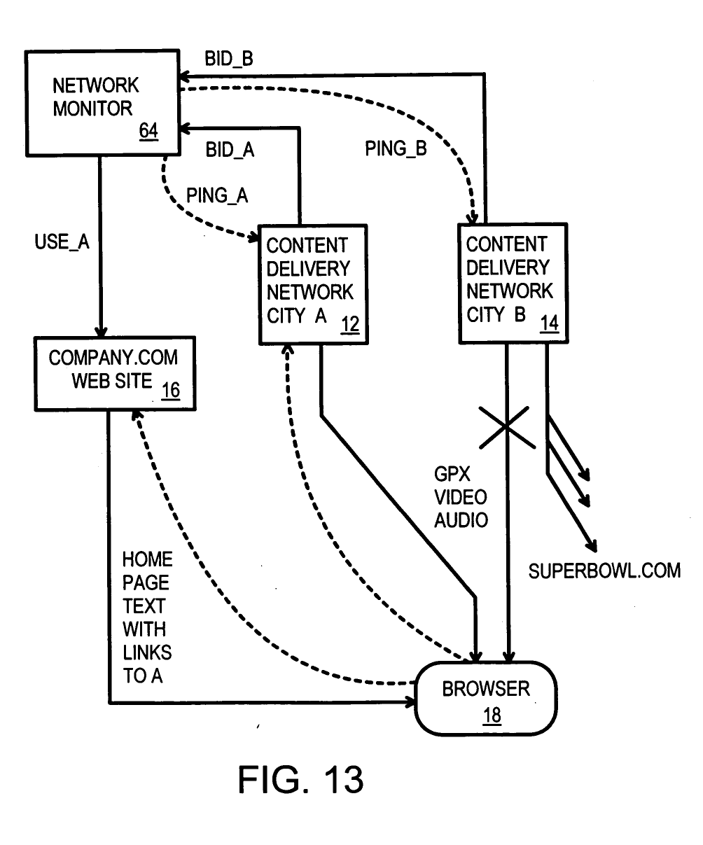

Highly-Available Web Site Selects Best Providers—FIG. 13

FIG. 13 highlights a link-modifying web server that monitors network conditions and directs users through modified links to a best-available content delivery provider. A content publisher (not shown) pushes content, such as web pages, graphics, video, and audio files to a corporate web server that operates the company.com web site 16, and to content delivery providers 12, 14 at remote cities A, B.

Browser 18 sends a request for a web page to web site 16. A link-modifying web server at web site 16 modifies the links within the requested web page, and sends the link-modified web page back to browser 18 over an Internet connection. Browser 18 then retrieves other files using these modified links, requesting the files from content delivery provider 12 or 14. Bandwidth-intensive files can be served from content delivery providers 12, 14 while low-bandwidth text files and web page HTML files are served from servers at web site 16.

Links are modified at web site 16 in response to input from network monitor 64. Network monitor 64 is coupled to content delivery providers 12, 14 by the Internet, and periodically tests the network response times. Costs for each content delivery provider 12, 14 can also be received by network monitor 64 or web site 16.

When a network failure occurs, such as at content delivery provider 14, browser 18 will not be able to retrieve files from content delivery provider 14 that are normally linked to web pages served by web site 16. These failures may appear to be caused by web site 16, since they occur when linking to files from this web site, even though the files physically reside at content delivery provider 14. To prevent browser 18 from seeing the failure at content delivery provider 14, network monitor 64 informs web site 16 to not use content delivery provider 14. Instead, links are modified to point to content delivery provider 12. The web page served by web site 16 to browser 18 thus is modified to contain links to content delivery provider 12 but not to content delivery provider 14.

Sometimes one content delivery provider 14 experiences a surge in traffic to one of the other company's hosted sites. Since the network connection and even server machines may be shared, performance for files served for company.com may also be slowed or stalled. Network monitor 64 detect this slowed performance and instruct web site 16 to modify links to point to other content delivery provider 12 until the traffic surge subsides. For example, a superbowl.com web site may be hosted by the same server machines at content delivery provider 14. Most of the time, performance of content delivery provider 14 is good. However, during the week of the Super Bowl, and especially on the Sunday of the game, performance is dismal. Network monitor 64 detects the poor performance and directs traffic to other content delivery providers 12.

Content delivery rates may also be received from each of content delivery providers 12, 14. These cost bids are factored into the decision on which content delivery provider 12, 14 to use for the modified links.

Advantages of the Invention

An automatic link modifier is used to select an optimum content delivery provider at runtime. A server-side run-time link modifier automatically modifies links on each web page as each web page is being server to the user. QA and deployment are more robust because the possibility of error during link modification is reduced.

Links are modified to allow content producers to easily and quickly change delivery providers in response to provider or server outages, to lower costs, or to provide better service. This allows the user to closely monitor the delivery provider and to quickly switch traffic from a delivery provider if a problem arises. It is also possible to set up an auction, where delivery providers bid for traffic, in order to minimize the cost of delivering content.

Links may be modified on a user-by-user basis so that content can be delivered from a content delivery provider that is geographically closest to the user, or that is selected from a content deliver provider based on the user profile or account level. Web sites can select delivery networks based upon which network is most appropriate for the user's location or which content deliver provider carries the content most suited for the user.

Alternate Embodiments

Several other embodiments are contemplated by the inventors. Rather than serve static web pages that are merely read from content storage, dynamic content can be served on the web page. A static portion of the web page is read from the content storage, and dynamic information, such as a current temperature or stock price, is added to the static content file. Alternately, the dynamic content can be called by the static content using a link to the dynamic content. This link can also be modified using the invention. The dynamic content could be a result of a database query, with the result being inserted or appended to the HTML file as the file is being served.

The methods described herein can be combined. For example, both keyword and rule-based link modifications can be used on the same web page. This provides more flexibility. Some links may cause a browser to automatically fetch the referenced files, while other links may not be fetched until a user activates the links, such as by clicking on the link. Image source tags typically cause most browser to immediately fetch the file, although some browsers may vary in operation, or allow users to vary the browser behavior. Since the links are modified as the web page is served, it does not matter whether the linked file is automatically or manually retrieved—the link still directs the user to the desired content delivery provider.

The file server and parser could be combined when serving dynamic content. As links are added to the file, they are checked against the link mapping database, and a modified link added to the file instead of the original link.

The link modification mechanism could be turned off by default, and turned on only when web site re-direction is needed, such as after a network failure. This can switch users to a backup site as needed. The default links could point to a default content delivery provider and then be modified to point to a different content delivery provider. Many arrangements of software modules, objects, and programs are possible. A variety of programming languages and techniques can be used. Firmware rather than pure software can be substituted.

Other web-page formats other than HTML and XML could be substituted. The link modifier may need to be updated to read these other file formats, and to locate links within the files. It is anticipated that HTML will continue to be updated, and that XML is only one of several variations of HTML than can be used with the invention. Cost parameters or other parameters used by the delivery rule processor can be added to each replacement entry in link mapping database. Other fields may also be present in the database.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A link-modifying web server comprising:
a network connection for receiving a request from a client for a web page file;
a file server for generating web page files;
a link modifier, receiving a web page file from the file server in response to a request from the client, for extracting an extracted link from the web page file, the extracted link for enabling fetching of a linked web file;
a link mapping database, coupled to receive the extracted link from the link modifier, for outputting a plurality of replacement fields for the extracted link, each of the replacement fields for generating a link to a different content delivery provider for serving the linked web file; and
a provider selector, receiving the replacement fields from the link mapping database, for selecting a selected replacement field for a selected content delivery provider;
wherein the link modifier receives the selected replacement field from the provider selector, the link modifier using the selected replacement field to generate a modified link in the web page file to generate a modified-link web page file;
wherein the network connection sends the modified-link web page file to the client;
wherein the client fetches the linked web file from the selected content delivery provider rather than from the link-modifying web server when the modified link is activated,
whereby links are modified to fetch the linked web file from the selected content delivery provider.

2. The link-modifying web server of claim 1 wherein the link modifier further comprises:
a link parser, receiving the web page file from the file server, for locating links within the web page file and for outputting the extracted link, the link parser for sending a plurality of extracted links to the link mapping database.

3. The link-modifying web server of claim 1 wherein the extracted link is a portion of a fully-specified link;
wherein the replacement fields contain a portion of a fully-specified link;
wherein portions of links are used as an index for selecting a matching entry in the link mapping database.

4. The link-modifying web server of claim 1 wherein the extracted link is a keyword extracted from an original link in the web page file,
wherein the link mapping database is indexed by keywords used to locate a matching entry in the link mapping database, the matching entry having the plurality of replacement fields,
whereby the keywords extracted from the original links are indexes for selecting the matching entry in the link mapping database.

5. The link-modifying web server of claim 4 wherein the keyword indicates a type of content in the linked web file, the type of content being a type of multimedia content including graphics, video, or audio.

6. The link-modifying web server of claim 1 wherein the extracted link is a full link that includes a high-level domain and a directory tree and a file name for the linked web file stored at the link-modifying web server,
whereby full links are used as an index for selecting a matching entry in the link mapping database.

7. The link-modifying web server of claim 1 wherein the link mapping database contains an index for each of the plurality of replacement fields, the index containing a link pattern that is able to match a plurality of different links;
wherein the link modifier compares the extracted link to the link pattern in the index of the link mapping database to select a matching entry with the replacement fields outputted to the provider selector,
whereby link patterns are matched.

8. The link-modifying web server of claim 1 wherein the selected replacement field is combined with an original link in the web page file that the extracted link was extracted from to generate the modified link.

9. The link-modifying web server of claim 8 wherein the selected replacement field is pre-pended to an original link in the web page file that the extracted link was extracted from to generate the modified link.

10. The link-modifying web server of claim 8 wherein the selected replacement field replaces a portion of the original link in the web page file that the extracted link was extracted from to generate the modified link.

11. The link-modifying web server of claim 10 wherein the web page file is a hyper-text mark-up language (html) file containing text and links, while the linked web file is a multimedia file displayed with the web page file on a browser at the client.

12. The link-modifying web server of claim 1 wherein the selected content delivery provider is selected based on measured performance.

13. The link-modifying web server of claim 12 further comprising:
a performance monitor, coupled to the provider selector, for measuring response times from each of the content delivery providers, the performance monitor sending a performance signal to the provider selector to indicate which content delivery provider has better response times;
wherein the provider selector uses the performance signal from the performance monitor to select the selected content delivery provider,
whereby content delivery providers are selected based on monitored performance.

14. The link-modifying web server of claim 13 wherein the performance monitor detects a failed content delivery provider, the performance monitor sending an indication of the failed content delivery provider to the provider selector;
wherein the provider selector avoids the failed content delivery provider when selecting the selected content delivery provider,
whereby failed networks are avoided by modifying links to avoid the failed content delivery provider.

15. The link-modifying web server of claim 1 further comprising:
a user database, receiving a user identifier from the client, for locating a user record for the user identifier;
wherein user criteria from the user record are sent to the provider selector, the provider selector using the user criteria to select the selected content delivery provider for the client,
whereby user criteria are used to modify links.

16. The link-modifying web server of claim 15 wherein the user criteria includes a location for the client;
wherein the selected content delivery provider is selected based on the location for the client and a location of the selected content delivery provider,
whereby geographic criteria are used for link modification.

17. The link-modifying web server of claim 16 wherein the user criteria includes a user priority level for the client;
wherein the selected content delivery provider is selected based on the user priority level for the client,
whereby user priority-level criteria are used for link modification.

18. The link-modifying web server of claim 1 further comprising:
a cost receiver, coupled to receive provider costs from the content delivery providers;
wherein the provider costs received from the content delivery providers are sent to the provider selector, the provider selector using the provider costs to select the selected content delivery provider for the client,
whereby costs of the content delivery providers are used for link modification.

19. The link-modifying web server of claim 18 wherein the provider costs are bids received from each of the content delivery providers;
whereby the content delivery providers bid for traffic from the link-modifying web server.

20. A computer-implemented method for directing traffic from a web-site server to a content delivery provider by link modification comprising:
at the web-site server, receiving a request over a network from a user at a remote client, the request specifying a requested file;
retrieving the requested file;
finding a link in the requested file, the link being a link to a linked file;
selecting a selected content delivery provider from a plurality of content delivery providers able to serve the linked file;
at the web-site server, altering the link to a modified link that points to the selected content delivery provider and not to other content delivery providers in the plurality of content delivery providers; and
transmitting the requested file with the modified link over the network to the remote client;
wherein the remote client reads the linked file from the selected content delivery provider,
whereby link modification re-directs the user from the web-site server to the selected content delivery provider.

21. The computer-implemented method of claim 20 further comprising:
monitoring performance of each of the plurality of content delivery providers;
detecting when a failed content delivery provider in the plurality of content delivery providers has poor performance;
selecting the selected content delivery provider from the plurality of content delivery providers that do not include the failed content delivery provider,
whereby users are directed to avoid failed content delivery providers by link modification and performance monitoring.

22. The computer-implemented method of claim 20 further comprising:
receiving a user ID from the user at the remote client;
reading a user database for a user record for the user ID;
selecting the selected content delivery provider based on criteria read from the user record,
whereby the user record is used to select the selected content delivery provider.

23. The computer-implemented method of claim 22 further comprising:
reading a user location from the user record;
selecting as a content delivery provider that is more-closely located near the user location than other content delivery providers when selecting the selected content delivery provider,
whereby the user location is used to select the selected content delivery provider.

24. The computer-implemented method of claim 23 further comprising:
reading a user level from the user record; selecting the selected content delivery provider based on the user level read from the user record,
whereby the user level is used to select the selected content delivery provider.

25. The computer-implemented method of claim 20 further comprising:
using at least a portion of the link from the requested file to find a matching entry in link mapping database;
selecting a selected replacement from a plurality of replacements in the matching entry, the selected replacement being for the selected content delivery provider while other replacements in the plurality of replacements are for other content delivery providers than the selected content delivery provider;
wherein altering the link to a modified link comprises using the selected replacement to alter the link,
whereby the link mapping database is read for the selected replacement.

26. A computer-program product comprising:
a computer-usable medium having computer-readable program code means embodied therein for modifying links in a web page served to a client, the computer-readable program code means in the computer-program product comprising:
network connection means for transmitting and receiving packets from the client;
server application means for receiving requests from the client and generating an original web page requested by the client;
parser means, receiving the original web page, for locating links to other web files within the original web page, the parser means outputting a first link string;
link mapping means, receiving the first link string, for outputting a replacement;
provider selection means for selecting a content delivery provider from among a plurality of content delivery providers that serve web files; and
link modifying means, receiving the replacement from the link mapping means, for modifying links in the original web page using the replacement to generate new links, the new links pointing to a selected content delivery provider selected by the provider selection means;
wherein the original web page with the new links is transmitted by the network connection means to the client,
whereby links are modified as web pages are served using a modified link to direct requests for the other web files from the selected content delivery provider.

27. The computer-program product of claim 26 wherein the computer-readable program code means further comprises:
cost comparison means, receiving provider costs from each of the plurality of content delivery providers, for selecting the replacement from the link mapping means as a function of the provider costs,
whereby links are modified as web pages are served to direct requests for the other web files to a lowest-cost content delivery provider.

28. The computer-program product of claim 26 wherein the computer-readable program code means further comprises:
performance measurement means for measuring the performance of each of the plurality of content delivery providers, and for selecting the replacement from the link mapping means as a function of measured performance,
whereby links are modified as web pages are served to direct request for other web files to a best-performing content delivery provider.

29. The computer-program product of claim 26 wherein the computer-readable program code means further comprises:
pattern matching means, coupled to the link mapping means, for matching links in the original web page to pattern links from the link mapping means to determine the replacement,
whereby link patterns are matched to select an entry in the link mapping means.

30. The computer-program product of claim 26 wherein the replacement contains a portion of a fully-specified link;
whereby portions of links are indexes for selecting a matching entry in the link mapping means.

31. The computer-program product of claim 26 wherein the first link string is a keyword extracted from an original link in the original web page,
wherein the link mapping means is indexed by keywords used to locate a matching entry in the link mapping means, the matching entry having the plurality of possible replacements,
whereby the keywords extracted from the original links are indexes for selecting a matching entry in the link mapping means.

32. The computer-program product of claim 31 wherein the keyword indicates a type of content in the original web page, the type of content being a type of multimedia content including graphics, video, or audio.

33. The computer-program product of claim 26 wherein the first link string is a full link that includes a high-level domain and a directory tree and a file name for the other web files,
whereby full links are indexes for selecting a matching entry in the link mapping means.

34. The computer-program product of claim 26 wherein the replacement is combined with an original link in the original web page to generate the new link.

35. The computer-program product of claim 26 wherein the replacement is pre-pended to an original link in the original web page to generate the new link.

36. The computer-program product of claim 26 wherein the computer-readable program code means further comprises:
user account database means, receiving a user identifier from the client, for locating a user record with user criteria for the user identifier;
wherein user criteria from the user record are sent to the link modifying means, the link modifying means using the user criteria to generate the new links pointing to a content delivery provider selected for the client;
whereby user criteria are used to modify links.

37. The computer-program product of claim 36 wherein the user criteria includes a location for the client;
wherein the new link is generated to point to a selected content delivery provider that is selected based on the location for the client and a location of the selected content delivery provider,
whereby geographic criteria is used for link modification.

38. The computer-program product of claim 36 wherein the user criteria includes a priority level for the client;
wherein the new link is generated to point to a selected content delivery provider that is selected based on the priority level for the client,
whereby user priority-level criteria are used for link modification.
